(19) United States
(12) Patent Application Publication
(10) Pub. No.: US 2005/0072354 A1
(43) Pub. Date: Apr. 7, 2005

(54) Painter's portable jig, leg assembly, and drying rack

(76) Inventor: Brad Arnold Goodwin, Harrisville, MI (US)

Correspondence Address: IRVING M. WEINER;WEINER & BURT, P.C., P.O. BOX 186, 635 N. US-23, HARRISVILLE, MI, 48740, US

(21) Appl. No.: 10/719,492

(22) Filed: Nov. 21, 2003

Related U.S. Application Data
(60) Provisional application No. 60/428,525, filed on Nov. 22, 2002.

(51) Int. Cl. B05C 11/02

(52) U.S. Cl. 118/108

(57) ABSTRACT

A painter's portable jig which allows doors to be painted on both sides in a horizontal position, a leg assembly for the portable jig, and a drying rack for the doors. All of the components of these devices may be conveniently disassembled to be stacked in a convenient arrangement for transportation or storage, and assembled at a work site with a minimum of effort.

The present patent application claims priority from and is based on U.S. Provisional Patent Application Ser. No. 60/428,525 filed Nov. 22, 2002.

The present invention relates generally to a novel and unique device which will allow doors to be painted on both sides in the horizontal position, a leg assembly therefor, and to a novel drying rack for such doors.

### BACKGROUND OF THE INVENTION

During the course of their work, professional painters typically paint or otherwise finish doors, of the type commonly found in houses and other buildings, either installed in the frame or leaning against the wall or other structure. Finishing a door in the vertical position, especially when using an airless or other type paint sprayer, can result in runs or sags in the finish due to gravity, overspraying onto adjacent surfaces, and an improper viewing angle for the painter.

Furthermore, because a typical construction site can range from very cluttered and dirty to well-maintained, but is rarely pristine, a door resting on or near the floor may have dirt or debris from the floor blown onto it by the sprayer as the finish is applied. If the door being finished is leaning against another structure, the finish must be applied to first one side, allowed to dry, turned, and the finish applied to the other side, a very time consuming process.

The prior, but not necessarily relevant, art is exemplified by Wood U.S. Pat. No. 5,090,648, Ray U.S. Pat. No. 5,164,011, and Speed et al. U.S. Pat. No. 6,090,204.

It is a desideratum of the present invention to avoid the animadversions of the current devices and techniques, and to provide a unique painter's portable jig, leg assembly, drying rack, and kit of components thereof.

### SUMMARY OF THE INVENTION

The present invention provides a portable jig for an elongated workpiece, comprising a substantially rectangular frame structure for surrounding said elongated workpiece; said substantially rectangular frame structure provides predetermined clearances between said substantially rectangular frame structure and said elongated workpiece; pivot means releasably connected to said substantially rectangular frame structure for pivoting said elongated workpiece within said substantially rectangular frame structure; and stabilizing means releasably connected to said substantially rectangular frame structure for stabilizing said elongated workpiece within said substantially rectangular frame structure when said elongated workpiece is being worked upon.

The present invention also provides a leg assembly for replacing a conventional sawhorse, comprising: a pair of vertical leg members; a pair of cross leg members affixed to said pair of vertical leg members; securement means at the top portions of said vertical leg members for releasably securing said vertical leg members to a portion of an external object to be supported by said leg assembly; and an adjustable angled support member releasably connectable at one end thereof to a predetermined portion of one of said vertical leg members, and releasably connectable at the other end thereof to a portion of said external object to be supported to maintain said leg assembly in orthogonal arrangement with said external object to be supported by said leg assembly.

The present invention also provides a drying rack for drying substantially flat elongated workpieces, comprising: an elongated L-shaped member which may be secured to an external support structure; said L-shaped member having an upper edge which is provided with a series of cutouts to accommodate at least one member protruding from said substantially flat elongated workpiece; and a cross member releasably securable to two or more of said substantially flat elongated workpieces to hold said workpieces in a substantially vertical position while said substantially flat elongated workpieces are drying.

It is a primary object of the present invention to provide a painter's portable jig which allows a door to be finished in a flat, horizontal position on both sides without the necessity of removing the door from the jig.

Another object of the invention is to provide a unique drying rack which permits a plurality of doors to be dried in a vertical orientation.

A further object of the invention is to provide a unique leg assembly which can be used with the portable jig to replace conventional saw horses.

Yet a further object of the invention is to provide a painter's portable jig as described above, wherein such jig may be transported and/or stored in an unassembled, convenient arrangement.

Another object of the invention is to provide a painter's portable jig as described above, wherein such jig is adjustable from approximately 6 foot 8 inches to 8 feet.

A further object of the invention is to provide a kit of components for said portable jig, leg assembly, and/or drying rack.

These and other objects and advantages of the present invention will become readily apparent to those persons skilled in this particular area of technology and to others upon reading the following specification and the accompanying drawings.

### BRIEF DESCRIPTION OF THE DRAWINGS

FIG. 1 illustrates a vertical elevational view of a door mounted on a painter's portable jig in accordance with a preferred embodiment of the present invention.

FIG. 2 depicts a top plan view of the apparatus shown in FIG. 1.

FIG. 3 illustrates a vertical elevational view of two doors mounted in the novel drying rack in accordance with a preferred embodiment of the present invention.

### DETAILED DESCRIPTION OF THE INVENTION

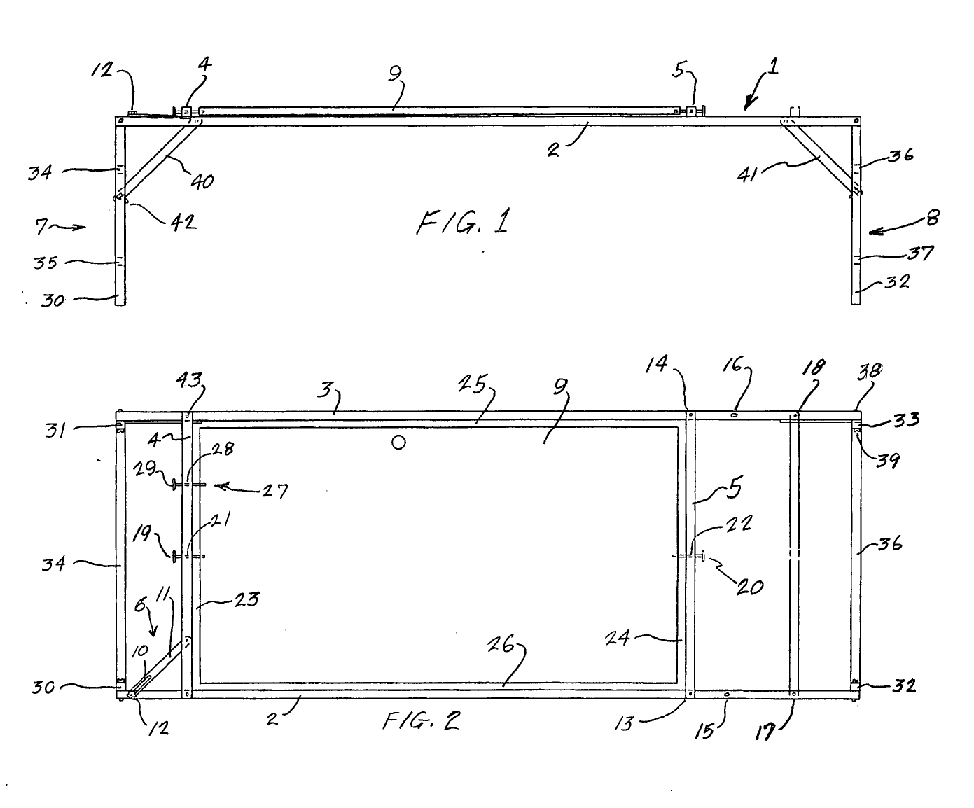

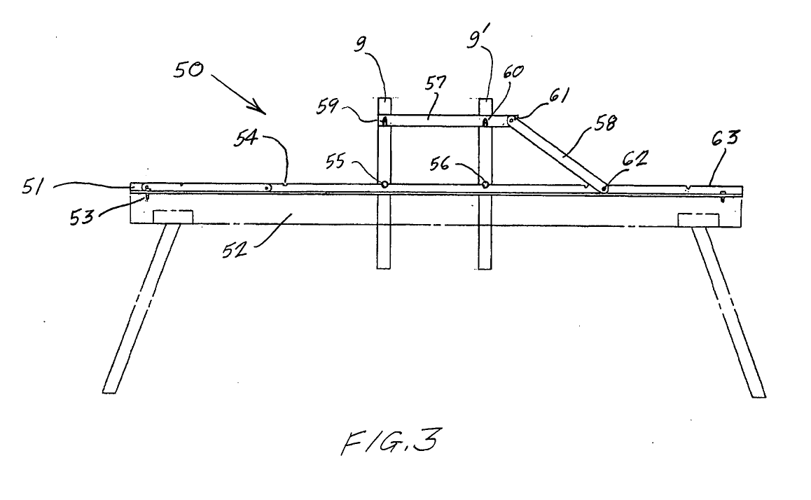

The painter's portable jig 1 according to the present invention is described in connection with FIGS. 1 and 2.

The main components of the jig 1 comprise a pair of elongated side members 2 and 3, a pair of cross members 4 and 5, and an adjustable squaring mechanism 6 for maintaining the assembled components 2, 3, 4 and 5 in a perpendicular arrangement.

The disassembled jig components 2, 3, 4, 5 and 6 may be stacked in a convenient arrangement for transportation or storage, and held together with eye bolts and wing nuts (not shown).

FIGS. 1 and 2 show the assembled jig 1 in its operative condition and supported on the novel leg assemblies 7 and 8 which preferably, but not necessarily, replace conventional saw horses. Before a door 9 is placed in the jig 1, the side members 2 and 3 and the cross members 4 and 5 are arranged in a perpendicular arrangement, and maintained in such perpendicular arrangement by the adjustable squaring mechanism 6 having a slot 10 in its main member 11 and secured by a knob and threaded bolt device 12. The adjustable squaring mechanism 6 is positioned near one corner of the jig 1 where one side member 2 meets one cross member 4.

The side members 2 and 3 are pre-drilled with various holes 13, 14, 15, 16, 17 and 18 to accommodate different sizes of doors 9. Preferably, but not necessarily, there are provided: a pair of pre-drilled holes 13 and 14 to accommodate a door 9 that is 6′8″ long; a pair of pre-drilled holes 15 and 16 to accommodate a door 9 that is 7′0″ long; and a pair of pre-drilled holes 17 and 18 to accommodate a door 9 that is 8′0″ long.

The door 9 is placed in the jig 1 and pivotally mounted thereon by two centrally-located pivot mechanisms 19 and 20, such as knob-handled lag screws, which pass through a pre-drilled hole 21 or 22 in their associated cross members 4 or 5, and then through the space 23 or 24 between the cross members 4 or 5 and the door 9, and then into the door 9 itself.

The jig 1 provides predetermined spaces or clearances 23, 24, 25 and 26 between the door 9 and the components of the jig 1. In this manner, the door 9 may be pivoted or rotated from one surface to another without interference with the cross members 4 and 5 or the side members 2 and 3.

A door stabilizing mechanism 27 is provided to hold the door 9 in a horizontal arrangement when one of its major sides is being finished or painted. Preferably, but not necessarily, the door stabilizing mechanism 27 comprises a pre-drilled hole 28 at a predetermined location in a cross member 4, cooperating with a knob-handled lag screw 29 which passes therethrough into the door 9. This door stabilizer mechanism 27 holds the door 9 in the horizontal position while a major surface of the door 9 is being painted. When it is desired to rotate or flip the door 9 so that the opposite major surface can be painted, or the edges of the door 9 can be painted, the door stabilizing mechanism 27 is temporarily removed to permit pivoting of the door 9.

The cross members 4 and 5 can be releasably assembled to the side members 2 and 3 by any suitable releasable connecting mechanisms 43, such as pins, D-rings, bolts, etc.

The portable jig 1 as described above can be supported, if desired, on conventional saw horses, and disassembled for transportation and/or storage in a convenient package. However, a preferable arrangement involves the unique disassemblable leg assemblies 7 and 8 described hereinbelow.

Preferably, but not necessarily, each leg assembly 7 or 8 comprises two vertical members 30, 3 or 32, 33 welded orthogonally to two cross leg members 34, 35 or 36, 37, respectively. The top portions of the vertical leg members 30, 31, 32 and 33 may be releasably secured to the end of the jig side members 2 and 3 by suitable bolts 38 and wing nuts 39. To maintain the leg assemblies 7 and 8 in orthogonal arrangement with the jig side members 2 and 3, there is provided a pair of angled support members 40 and 41 for securement to one of the jig side members 3. Such angled support members 40 and 41 are releasably secured to the jig side member 3 and a vertical leg member 31 or 33, respectively, by releasable D-pins 42.

Although only two angled support members 40 and 41 are shown in the drawings, there can, of course, be three or four such members used if desired.

It should be appreciated that upon disassembly, the leg assemblies 7 and 8 and the components of the portable jig 1 can all be disassembled conveniently for storage and/or transportation, and assembled on site with a minimum of effort.

It will be appreciated that after the doors 9 have been painted or finished using the apparatus shown in FIGS. 1 and 2, it is desirable and necessary to arrange for the painted doors 9 to dry properly. For this purpose, the novel and unique drying rack 50 depicted in FIG. 3 is utilized.

The drying rack 50 includes an elongated L-shaped member 51 which is secured to a common saw horse 52 with screws 53. Such L-shaped member 51 may preferably, but not necessarily, comprise a 1½ inch by 1½ inch by 48 inches long by 1/8 inch thick angled aluminum member. The upper edge 63 of the L-shaped member 51 is provided with a series of cutouts 54 to accommodate T-handle screws or lag bolts 55 and 56. Such T-handle screws or lag bolts 55 or 56 are positioned centrally in the door edge where the central pivot mechanisms 19 and 20 shown in FIGS. 1 and 2 were placed.

FIG. 3 shows two doors 9 and 9¹ being supported in the drying rack 50. Remote from the viewer of FIG. 3, on the opposite side of the doors 9 and 9¹, is another portion of the drying rack 50 similar to that described hereinabove.

The portion of the drying rack 50 shown in FIG. 3 is provided with a cross member 57 to hold the doors 9 and 9¹ in vertical position while drying, with such cross member 57 being connected to the L-shaped member 51 by a support bracket 58. Preferably, but not necessarily, such support bracket 58 may comprise an aluminum or mild steel member which is 1/16 of an inch by ¾ of an inch by 11 inches.

Suitable fastening members 59, 60, 61 and 62 are employed for releasably interconnecting the cross member 57 to the doors 9 and 9¹, and for pivotally interconnecting the support bracket 58 to the L-shaped member 51 and the cross member 57. Only one such cross member 57 and support bracket 58 is necessary for holding the drying doors 9 and 9′ in position while drying.

Although FIG. 3 shows only two doors 9 and 9′ being held while drying, the drying rack 50 is provided with sufficient cutouts 54 and space to accommodate three or more doors.

The present invention also provides a novel kit of components, taken singly or in combination, for the painter's portable jig 1, the novel leg assemblies 7 and 8 therefor, and the novel drying rack 50.

The foregoing description of some preferred embodiments of the present invention has been presented for the purpose of description and illustration only, and not for limitation. It is not intended to be exhaustive or to limit the invention to the precise form and components disclosed. Many modification and variations are possible in light of the above description, and will occur to those persons skilled in this area of technology and to others after having read the present patent application.

1. A portable jig for an elongated workpiece, comprising:
a substantially rectangular frame structure for surrounding said elongated workpiece;
said substantially rectangular frame structure provides predetermined clearances between said substantially rectangular frame structure and said elongated workpiece;
pivot means releasably connected to said substantially rectangular frame structure for pivoting said elongated workpiece within said substantially rectangular frame structure; and
stabilizing means releasably connected to said substantially rectangular frame structure for stabilizing said elongated workpiece within said substantially rectangular frame structure when said elongated workpiece is being worked upon.

2. A portable jig according to claim 1, wherein:
said substantially rectangular frame structure comprises a pair of side members and a pair of cross members which are releasably connected to said side members; and
said substantially rectangular frame structure includes adjustment means which permits at least one of said cross members to be adjustably moved and releasably secured to said pair of side members to accommodate various sizes of said elongated workpiece.

3. A portable jig accordingly to claim 1, including:
an adjustable squaring mechanism for maintaining said substantially rectangular frame structure in a perpendicular arrangement.

4. A portable jig accordingly to claim 2, including:
an adjustable squaring mechanism for maintaining said substantially rectangular frame structure in a perpendicular arrangement.

5. A portable jig accordingly to claim 1, including:
a pair of disassemblable leg assemblies for releasably supporting said substantially rectangular frame structure; and
a pair of angled support mechanisms connecting said leg assemblies to said substantially rectangular frame structure to maintain said leg assemblies in orthogonal arrangement with said substantially rectangular frame structure.

6. A portable jig accordingly to claim 2, including:
a pair of disassemblable leg assemblies for releasably supporting said substantially rectangular frame structure; and
a pair of angled support mechanisms connecting said leg assemblies to said substantially rectangular frame structure to maintain said leg assemblies in orthogonal arrangement with said substantially rectangular frame structure.

7. A portable jig accordingly to claim 3, including:
a pair of disassemblable leg assemblies for releasably supporting said substantially rectangular frame structure; and
a pair of angled support mechanisms connecting said leg assemblies to said substantially rectangular frame structure to maintain said leg assemblies in orthogonal arrangement with said substantially rectangular frame structure.

8. A portable jig accordingly to claim 4, including:
a pair of disassemblable leg assemblies for releasably supporting said substantially rectangular frame structure; and
a pair of angled support mechanisms connecting said leg assemblies to said substantially rectangular frame structure to maintain said leg assemblies in orthogonal arrangement with said substantially rectangular frame structure.

9. A leg assembly for replacing a conventional sawhorse, comprising:
a pair of vertical leg members;
a pair of cross leg members affixed to said pair of vertical leg members;
securement means at the top portions of said vertical leg members for releasably securing said vertical leg members to a portion of an external object to be supported by said leg assembly; and
an adjustable angled support member releasably connectable at one end thereof to a predetermined portion of one of said vertical leg members, and releasably connectable at the other end thereof to a portion of said external object to be supported to maintain said leg assembly in orthogonal arrangement with said external object to be supported by said leg assembly.

10. A leg assembly according to claim 9, wherein:
said external object to be supported by said leg assembly comprises a portable jig having side members; and
said angled support member is releasably connected between said one of said vertical leg members and one of said side members of said portable jig.

11. A leg assembly according to claim 9, wherein:
said leg assembly can be disassembled conveniently for storage and/or transportation, and assembled at a work site with a minimum of effort.

12. A leg assembly according to claim 10, wherein:
said leg assembly can be disassembled conveniently for storage and/or transportation, and assembled at a work site with a minimum of effort.

13. A drying rack for drying substantially flat elongated workpieces, comprising:
an elongated L-shaped member which may be secured to an external support structure;
said L-shaped member having an upper edge which is provided with a series of cutouts to accommodate at least one member protruding from said substantially flat elongated workpiece; and
a cross member releasably securable to two or more of said substantially flat elongated workpieces to hold said workpieces in a substantially vertical position while said substantially flat elongated workpieces are drying.

14. A drying rack according to claim 13, including:
a support bracket releasably connectable between said upper edge of said L-shaped member and said cross member to assist in holding said substantially flat elongated workpieces in substantially vertical position while said workpieces are drying.

15. A drying rack according to claim 13, wherein:
said substantially flat elongated workpieces comprise doors.

16. A drying rack according to claim 14, wherein:
said substantially flat elongated workpieces comprise doors.

17. A drying rack according to claim 13, wherein:
said external support structure comprises a sawhorse to which said L-shaped member may be secured.

18. A drying rack according to claim 14, wherein:
said external support structure comprises a sawhorse to which said L-shaped member may be secured.

19. A drying rack according to claim 15, wherein:
said external support structure comprises a sawhorse to which said L-shaped member may be secured.

20. A drying rack according to claim 16, wherein:
said external support structure comprises a sawhorse to which said L-shaped member may be secured.
